(19) United States
(12) Patent Application Publication
(10) Pub. No.: US 2003/0149674 A1
(43) Pub. Date: Aug. 7, 2003

(54) Shipment monitoring method and system

(75) Inventors: Gary E. Good, Stafford, NY (US); Todd J. Bender, Batavia, NY (US); Andrew J. Young, Batavia, NY (US)

Correspondence Address: Stephen B. Salai, Esq., Harter, Secrest & Emery LLP, 1600 Bausch & Lomb Place, Rochester, NY, 14604-2711, US

(73) Assignee: PakHound, Inc., Batavia, NY

(21) Appl. No.: 10/345,652

(22) Filed: Jan. 16, 2003

Related U.S. Application Data
(60) Provisional application No. 60/353,289, filed on Feb. 1, 2002.

(51) Int. Cl. G06F 17/60

(52) U.S. Cl. 705/402; 705/1

(57) ABSTRACT

This invention provides for a web based service that allows shipping service users to track the status of delivery of their shipments with multiple carriers and determine shipments that are delivered late relative to the service levels committed by the carriers based on user supplied information. Further, the shipped-shipment monitoring system enables identification of the late shipments and the ones eligible for refunds and allows for refund claims to be processed with the respective carriers. The system further enables tracking of the refunds to ensure proper credits are passed on by the carriers to the users of the system. The portal based web service allows the users to access reports on various events relating to their shipping services in order to manage pricing, revenue-sharing and costing of such services. The methodology and system allows for communication between the users, carriers and authorized third parties and/or administrators who are connected to the system.

### CROSS-REFERENCE TO RELATED APPLICATIONS

This application claims priority to provisional application Serial No. 60/353,289 entitled “Web Service Method & System for Package Shipping Refunds” filed Feb. 01, 2002.

### BACKGROUND OF THE INVENTION

1. Field of the Invention

The present invention relates to monitoring “shipments” and more particularly, to the field of information technology-based e-commerce, web based delivery, shipment tracking, shipping-service coordination and shipping-transaction processing including a web-portal interface to identify, calculate and request refunds in response to a difference between a calculated delivery date and an actual delivery date for a given shipment.

2. Description of Related Art

Third party or private carriers of parcel shipments deliver approximately 20 million shipments a day. Many of these carriers provide level-of-service guarantees, including a guaranteed delivery date and/or time. Tracking numbers are typically assigned to every shipment and enable users of shipping services and especially overnight shipping services, to ensure delivery of their shipments to the respective destinations.

The tracking number is usually entered at various stages of the shipment route within the carrier. To facilitate entry of the tracking number, the tracking number is typically expressed as a machine-readable bar code. Thus a shipment is “scanned in” at various locations in the shipping process.

The method of managing and tracking shipments by carriers has traditionally been one where a request is initiated by a user of the shipping services (user), with a phone call to the customer service department of the carrier. With the onset of the internet and email, some carriers have made it possible to email a request or to check the status of a shipment by manually entering the tracking number at a particular website. Current methods allow a user to enter a plurality tracking numbers at one time at the respective websites of participating carriers in order to allow shipping service users to track shipped shipments.

Some carriers guarantee delivery or a refund of the shipping charges if shipping is delayed. A user may request a refund or credit for transportation charges from a carrier if the carrier misses the published or quoted delivery times by even one minute, or if the carrier cannot report on the status of the shipment within a specified period from the time the inquiry is made.

Carriers appear to have their own logistical inefficiencies. Typically, approximately 2% to 8% of all shipments arrive late. Some delays can be attributed to illegible address for a recipient, or for a recipient not being available for signature. It is believed that a major cause of the delays is because the carriers operate at peak capacity on some days with less efficiency than they have committed to the users of the shipping services. It is estimated that up to approximately one million of the 20 million shipments shipped daily by private carriers are not delivered to their destinations at the time committed by the level-of-service guaranteed by the carrier. This represents a significant cost to the user and, for the universe of users, a lost opportunity to claim eligible refunds.

The current methods of tracking and making refund requests is inefficient for users, and not very conducive for large users who might be shipping hundreds or thousands of shipments daily. These refund requests are time sensitive. There is a new opportunity resulting from combining the needs of these large users and their desire to obtain refunds and thus contain costs by paying the carriers only for shipments that are delivered on time and claiming refunds where they might be entitled to do so.

Therefore, there is a need to efficiently identify late deliveries, then request and obtain refunds from the carrier in a timely manner. The need exists for a system and method that can be used to reduce shipping costs, and increase the profit of the users. The further need exists for a sufficiently low cost system and method to justify the expense in recovering the refunds.

### BRIEF SUMMARY OF THE INVENTION

The present invention provides a system and method for obtaining refunds and information from shipment carriers for failure to meet guaranteed delivery schedules and other shipment related information. This invention is designed for convenience and efficiency since claiming eligible refunds involves a number of steps, programs and carriers and very few users have the time, patience or know-how to claim such refunds efficiently. Many users cannot justify the time and effort involved in making the eligible claim.

Generally, the present method and apparatus involves obtaining, from a user shipping information sufficient to calculate a shipping date, time, carrier, and a service type for a given shipment by a given carrier, calculating an expected delivery date for the shipment corresponding to the shipping date and the service type, then comparing the expected delivery date to a reported delivery date from the carrier to determine an eligible refund, and requesting the refund corresponding to eligibility based on this information. This method can be used by a shipping services user to calculate the expected delivery date and request the refund or by a third party who can act as an agent for the shipping services user, wherein the refund can be shared between the user and the third party. The method can also track the processing of refund requests made to the carrier by the shipping services user or a third party and the delivery statistics by carrier or other relevant parameters.

### BRIEF DESCRIPTION OF THE SEVERAL VIEWS OF THE DRAWING

FIG. 1 is a flowchart of the web service system for shipment refund management according to the methodology of the invention.

FIG. 2 is a flowchart of the shipped-shipment monitoring system 10 according to the system of the invention.

FIG. 3 is a flowchart of the refund request process according to the system of the invention.

FIGS. 4-8 are screenshots of the web-service portal.

### DETAILED DESCRIPTION OF THE INVENTION

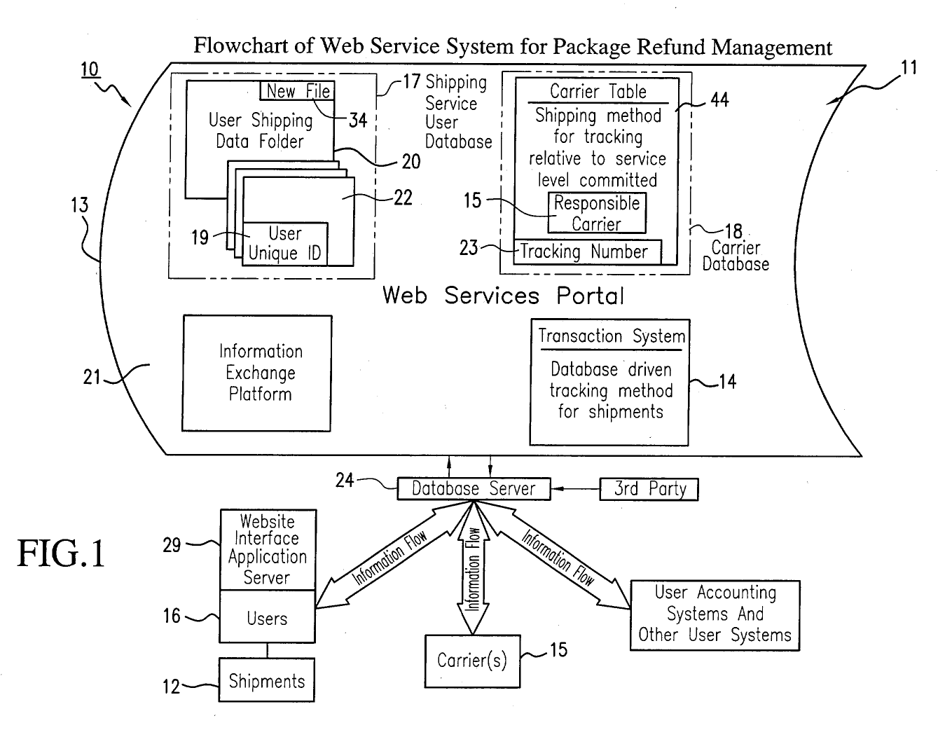

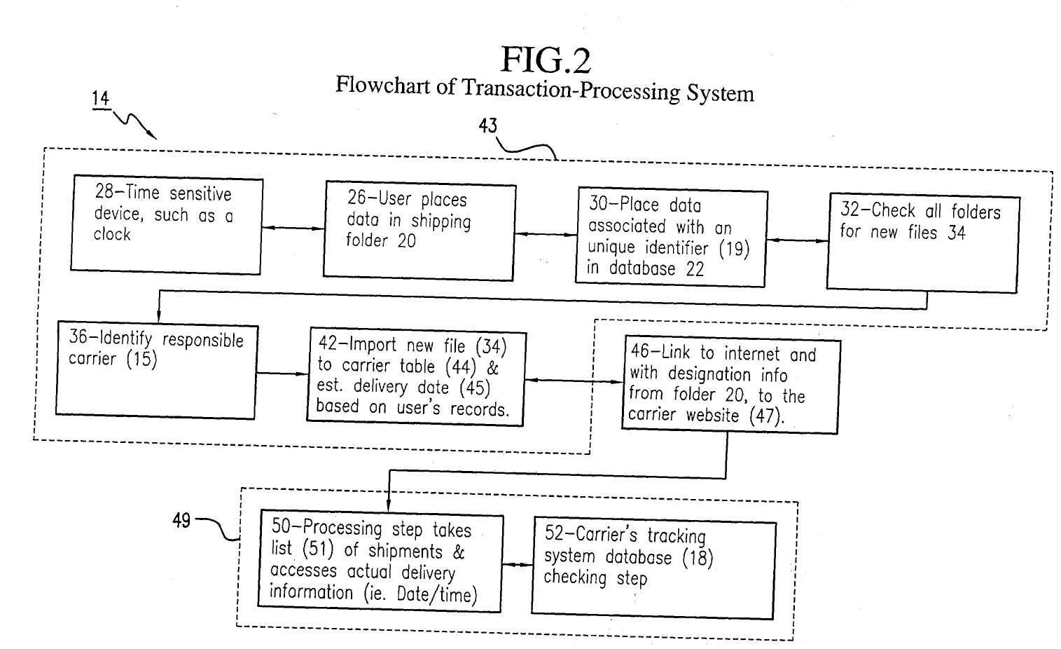

The invention is a shipment monitoring system 10, including associated software 11 and methodology for identifying entitlement to a refund for late delivery of a shipment 12. The shipment monitoring system 10 can include a web-based service delivered by a portal 13 as shown in FIG. 1, including a transaction and refund processing system 14 for tracking a shipment by a carrier 15 on behalf of a shipping service user 16. The transaction and refund processing system 14 can be interconnected with both a shipping service user database 17 and a carrier database 18 using the internet. The databases can be accessed by the respective company. The user data base 17 can be maintained by a third party or any combination of the above. In FIG. 2 they are shown as part of the monitor system 10 but it is understood that they could stand alone.

The processing and service method enables users, with the specifically designed software 11, to accurately track shipments 12 to determine if the shipments are late and therefore eligible for refund(s). The shipment monitoring system 10 and associated method verify the date and time the shipments are due at their respective destinations and compare those dates, times, and destinations to the delivery attempts.

This invention compares calculated delivery from the user information to the exact date and time the deliveries are made by the carrier 15 using software 11. The shipment monitoring system 10 enables users 16 to automatically and speedily recover eligible refunds to their accounting systems thus lowering overall shipping costs and gaining cost efficiencies. These refunds can be requested directly by the user 16 or by a third party acting as an agent for the user 16. The user can obtain the refund directly, have a third party obtain the refund for a fee, have the third party direct payment to the user directly, take the refund and send a portion to the user, or any combination of the above.

Carriers 15 use numbers such as tracking numbers, reference numbers, invoice numbers, or purchase order numbers to track a user's shipments as they flow through the carrier delivery system. These are often referred to collectively as a tracking number. The user can enter any combination of tracking numbers to obtain results such as status, destination, date and time of delivery information from the specific carrier's records. For more detailed results, a user would have to typically access second level details, which might reflect results like the name of the person who signed for the shipment, and other details and explanations such as failed delivery attempts.

The manual process of tracking and determining which shipments are delayed and therefore eligible for refund, is fairly labor intensive and time consuming. Attempts to determine eligible refunds involve first conducting a batch process manually or searching the database of the respective carrier to find out which specific shipments are delivered late. Secondly by a separate manual process or a phone call, requesting the customer service department of the respective carrier to file a claim for the eligible refund. Presently only a small percentage of shipments that qualify for refunds are claimed in industry without the help of this invention. These claims are time sensitive so a time efficient system is needed.

Shipped-Shipment Monitoring System And Process Flow

FIG. 1 shows the shipment monitoring system 10, hereafter referred to as the monitoring system 10, for shipment refund management according to the methodology of the invention. The monitoring system 10 contains the specially-designed software 11 which is discussed in detail below, to enable the accurate tracking of shipments 12 to determine if the shipments are late and therefore eligible for refunds. The monitoring system 10 is such that both the web server and an application server can access a common database, such as the user's database 17, accessible by the user 16, to retrieve data. The application server can also connect with the web server when the import process is running. The primary function of the web server is to allow the user 16 to place data into a user shipping data folder 20, such as in an upload, and to view on a web site 21. The user 16 is also able to view reports which are contained in a user database 22 residing on the database server and identified by a unique user identification number 19, and further identified by a carrier tracking number 23, as discussed above. The primary function of a database server 24 is to hold all the data for the monitoring system 10 and make it available to both the web server and the application server. The application server is used to import data from the user's uploaded files and to track shipments 12 with the help of the transaction and refund processing system 14 hereafter referred to as the transaction processing system 14.

Basic Application Flow

A first step 26 in the transaction processing system 14 is shown in FIG. 2. This process uses a time sensitive device, such as a clock 28 to trigger the monitoring system 10 to place, such as by uploading, the user shipping data into the folder 20 using a web site interface 29 (see FIG. 1). In a second step 30 the user shipping data is placed in folder 20 identified by the user's unique identification number 19. This process is repeated based on preset time intervals, for example hourly, controlled by the clock 28. In a third step 32 the monitoring system checks all the folders 20 for any data files 34 that might have been uploaded.

When the data file 34 is found then a fourth step 36 is performed to determine who is the responsible carrier 15 associated with the data file 34. Then the data file 34 is imported in a carrier import step 42 into a carrier table(s) 44 in the data base 22. These first five steps are often referred in total as an import process 43 of the transaction processing system 14. The system is capable of having all voided shipments, ineligible shipments, or other categories, be automatically ignored and as such not imported into the company table(s) 44 if desired. The stored shipping information can be used for many purposes, including as cost analysis or efficiency comparisons. The import process 43 is designed to automatically check each shipment amongst the uploaded files to see if the shipment 12 already exists in the monitoring system database 22.

The monitoring system 10 captures and/or calculates an expected delivery date 45 or other delivery information from records maintained by the user, carrier or a third party system using appropriate designation information, such as origin and designation postal codes. The monitoring system 10 takes into account if the user uses a specific type of service, such as ground service. This is called the user-information capture step. The expected delivery 45 includes the delivery date and time as well as other important delivery information important to the user or shipment such as an associated person, delivery location, refund, exception, payment, validation, duplicate charge and/or other associated charges. Next the monitoring system 10 makes a link 46 to the carrier's web site using the appropriate information from the user database 22 which can include the carrier's name. The link 46 to the carrier web site 47 is accomplished by a communication protocol and devices, for example, an electronic data interface.

A calculation step 49 occurs next. This usually occurs after all the user data files 34 have been imported into the system with their unique identification numbers 19 and the appropriate designation information has been used to calculate the expected delivery date 45. The calculation step 49 starts with a processing step 50 when a user's shipment list 51 in the database 22 is accessed and loaded. This step takes the user's shipment list 51 which includes one or more carrier specific data items including information about shipments that were shipped for the user by that carrier. In one configuration this list will identify only new shipments that have been recently imported from those non-delivered shipments whose expected delivery dates have passed. Next a database checking system step 52 compares the expected delivery 45 on the shipment list 51 to the actual delivery date contained in the carrier's tracking system database 18. The database checking system step 52 checks to identify late shipments by comparing the expected date to the actual delivery date, also referred to as a receiving date, listed in the carrier's database 18.

During the calculation step 49, the monitoring system 10 sends out a request for each shipment 12 to the carrier's database 18 for tracking details. The carrier's database 18 then responds, or the actual delivery dates are obtained another way such as via an imported field. In the preferred configuration the monitoring system 10 parses the response for delivery status, and the last scan date\time. The monitoring system 10 then checks to see if the shipment has a ship date assigned to it by the carrier 15. If the shipment does not have a ship date, the response is searched automatically for a ship date, and if still not found, one of the dates such as origin scan, pickup scan or pickup manifest received is sought for. Once the ship date (or timing initiation date) is known or determined, the processing system can compute the expected delivery and confirm that the package has been delivered.

If the shipment has then been delivered, the monitoring system 10 checks the last scan date\time against the expected (calculated or otherwise estimated) delivery date\time. If the actual delivery date\time is past the expected delivery (date/time) the shipment is marked as late. If the shipment is not late, it is marked as on time or other appropriate designation like an exception, damaged, or in transit. The system checks the current date\time against the expected delivery date if the shipment is not delivered. If the current date\time is past the expected delivery date\time, the shipment is marked as late.

A unique feature of this monitoring system 10 is that the monitoring system 10 can compare the expected date and time of delivery, based on user-supplied data contained in the data file 34, to the actual performance of the carrier. This enables the monitoring system 10 to determine when shipments 12 are even a minute late. The monitoring system 10 can determine if the actual delivery is within any of the carrier guarantees or other shipment based criteria, and thus flag any shipments that are out of compliance. The monitoring system 10 is different from other systems that attempt to merely tag late shipments based on the assessment of the carriers themselves. This gives the shipment monitoring system the possibility of comparing against the guarantees committed by the carriers to the user and confirming the dates that were originally calculated.

The data uploaded in the user shipping folder 20 by the user 16 is received by the portal 13 and processed according to the monitoring system 10 of this invention. Each field is compared to the database of the carrier to identify dates and times and delivery commitments. This way the monitoring system 10 determines the specific shipments 12 that are late, ultimately leading to a process for claiming the eligible refunds based on the late shipments. The monitoring system 10 works to:

1. Automate the tracking of late shipments by comparing the databases of the users and the carriers by different fields.

2. Ascertain the lateness based on committed delivery dates and times depending upon the level of service and the actual performance.

3. Short-list the late shipments that are eligible for refunds.

4. Claim the refunds from the carriers on behalf of the user.

5. Ensure that the refunds are credited or paid the user's accounts within a certain time frame.

6. Use the shipment data collected by the system to evaluate shipping histories and to optimize future deliver practices by choosing appropriate carriers, routes and shipment methods procedures.

The monitoring system 10 can collect shipping data and information that can also be used for reporting, audit and payment purposes. This data can result in cost reductions, a just in time inventory, efficiencies, and better service. The collected data can also be used for warehouse design considerations, distribution designs, zone analysis including manifested and not shipped, least cost routing, zone skipping, as well as other logistics services, including lost and in transit packages. All of this data is useful in optimizing rate negotiations and delivery choices for a user.

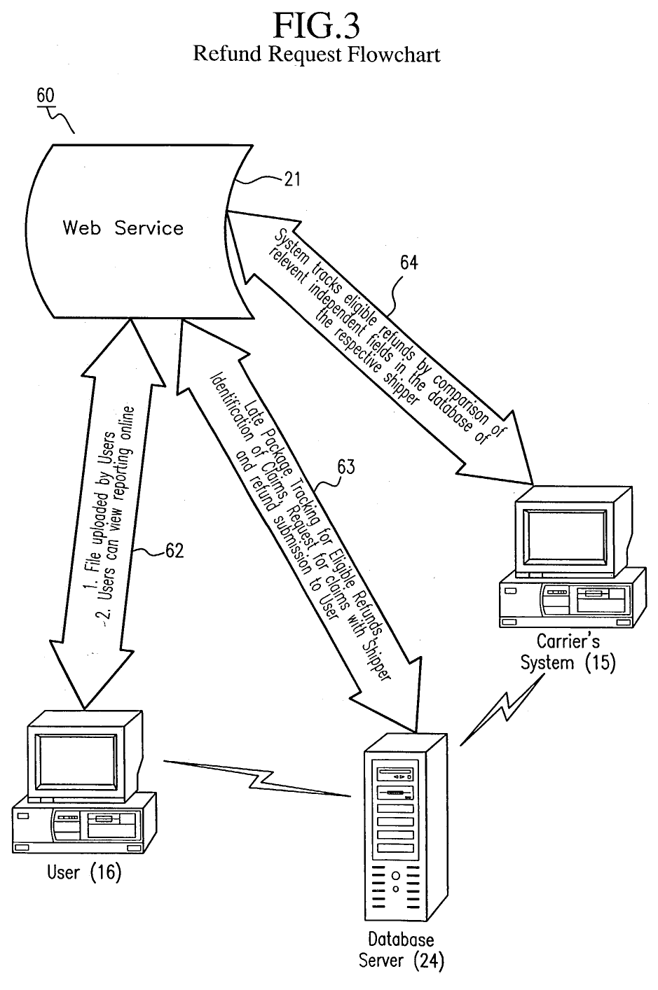

FIG. 3 is a flowchart of a refund request processing system 60 of the monitoring system 10, according to the invention. Once the late shipments are identified through the transaction processing system 14 of this invention, a refund request processing system 60 allows a refund to be made by the carrier 15 to the user 16 or third-party. The user 16 can access the web server to upload data or check for shipping information, such as eligibility refunds, in the user's database 22 using the user's unique identification number 19 as shown in step 62. Alternately, the monitoring system 10 can do this automatically. The processing system 60 also allows late package or out of specification tracking 63, as discussed above, and can communicate 64 with the carrier's database in one embodiment.

The users 16 can view the user data in the user database 22 and any relevant shipping information, whenever they desire. The database structure is based on open architecture ODBC standards and allows interaction with other accessible, relevant databases through database programs, office automation tools, and handheld wireless devices using programs such as Access, Excel, ODBC, Palm, CE, etc. This makes this monitoring system a powerful tool for all the user's shipments and shipment monitoring needs, including refunds, economic analysis, carrier comparisons and even contract negotiations. Since the monitoring system 10 can update the files at preset time intervals, as arranged by the user 16 and/or third parties so that all user data will be up to date when a user logs on to view them.

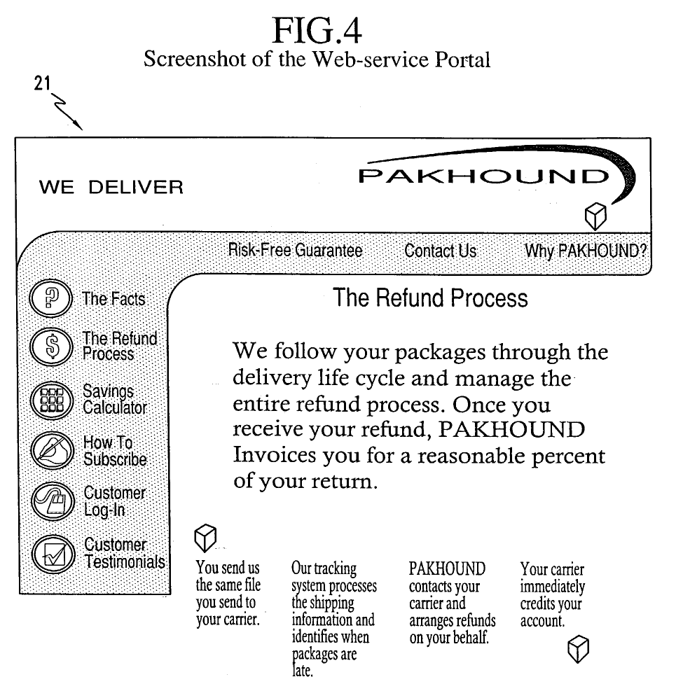

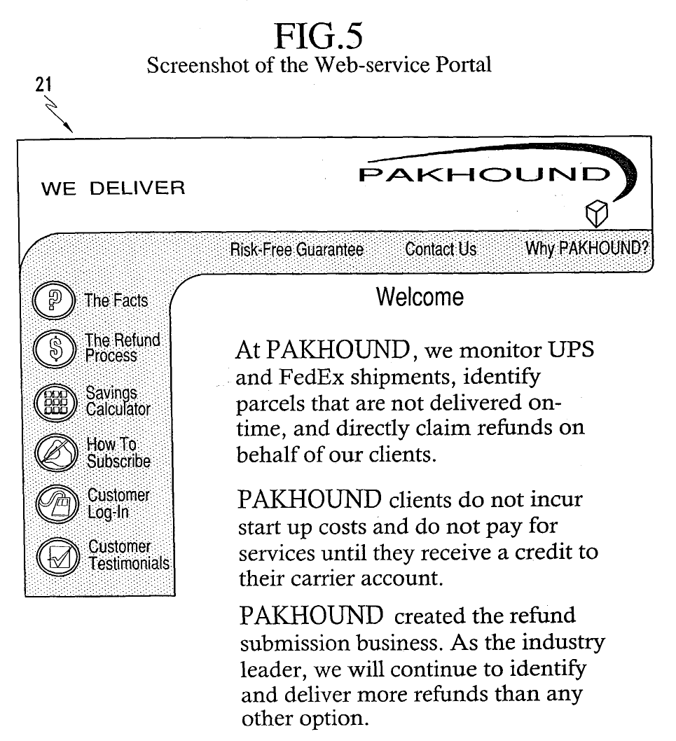

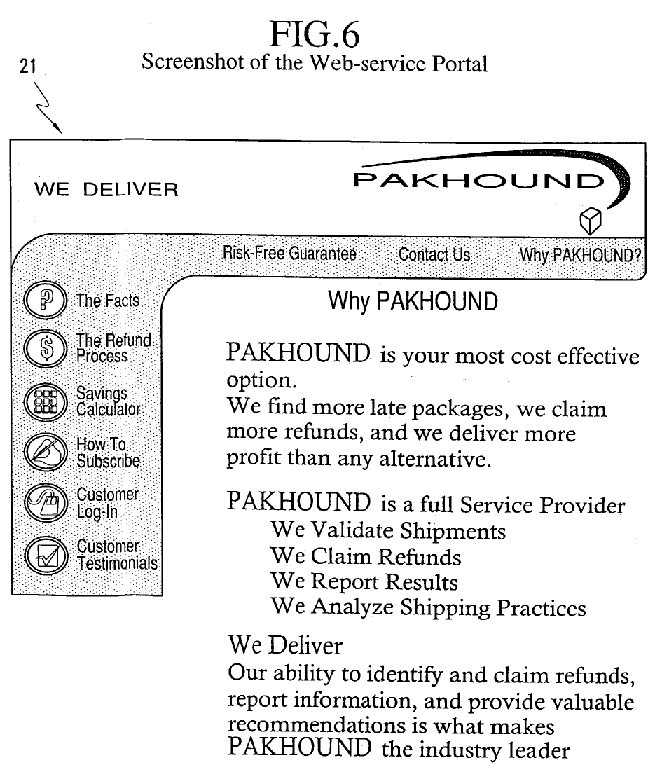

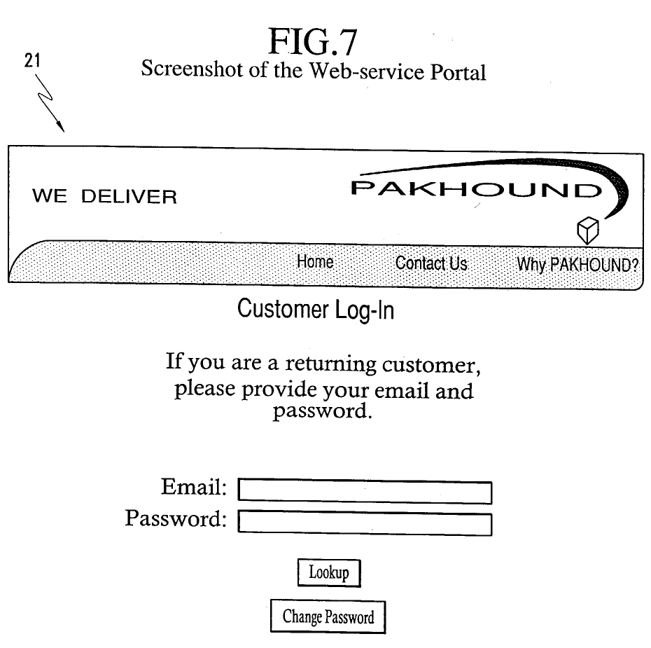

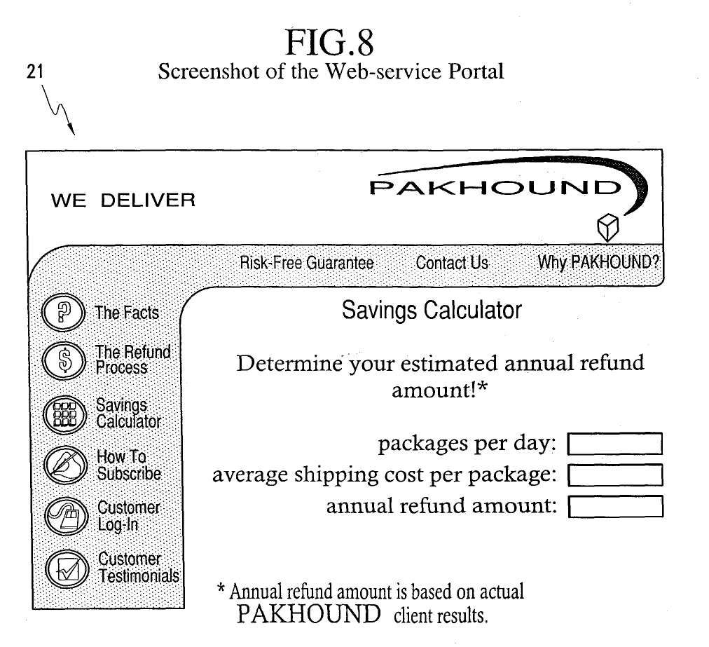

The requested refund can go directly to the user 16 or to a third party as discussed above. Payment for a third party might be a percentage of the total refund or an amount per time period or shipping volume. FIGS. 4 through 8 show simulated screenshots of the web-service portal showing how a user actually uses the portal 13 to access the web service according to the system of the invention.

The shipment monitoring system 10 closes the gap between the need for savings and the present high cost of obtaining refunds with the present state of the art. The current invention combines a method of tracking late shipments and an automated process for efficiently tracking the eligible refunds and claiming the same from the carrier on behalf of the user as a complete interlinked web service. This new method and system allows users to efficiently obtain refunds and reduce their shipping costs as a result of having to pay only for shipments that meet the service level criteria of the user.

While the invention has been described in connection with a presently preferred embodiment thereof, those skilled in the art will recognize that many modifications and changes can be made therein without departing from the true spirit and scope of the invention, which accordingly is intended to be defined solely by the appended claims.

We claim:

1. A method for identifying an entitlement to a refund for late delivery of a shipment, including a web-based service delivered by a portal and a transaction and refund processing system for tracking the shipment by a carrier on behalf of a shipping service user, the transaction and refund processing system being interconnected with a database of the shipping service user and the carrier using the internet, the method comprising:
(a) receiving at the transaction and refund processing system, shipping information of the shipment by the carrier from the shipping service user;
(b) calculating an expected delivery date and time for the shipment corresponding to the received information;
(c) receiving an actual shipment delivery information, including date and time, from the carrier;
(d) determining in response to the expected delivery date and time, and the actual delivery date and time, if the shipment is delivered late; and
(e) determining a refund eligibility for a late delivery of the shipment.

2. The method of claim 1, further comprising:
(f) processing a refund claim with the carrier to enable the shipping service user to receive credit for the late delivery.

3. The method of claim 2, further comprising:
(g) ensuring that the due credit is received by the shipping service user from the carrier; and
(h) reporting the tracking and identification of late shipments as well as eligible refunds and a status of each of these events to the shipping service user.

4. The method of claim 1, further comprising:
(f) reporting the data by carrier if more than one carrier is used; and
(g) reporting the data by the carrier level of service.

5. The method of claim 1, further comprising:
(f) providing online reseller business services portal for tracking, identification, viewing of late shipments to enable refunds; and reporting of the tracking and identification of late shipments.

6. The method of claim 1, further comprising:
(f) transmitting the information via an electronic linking mechanism using web-based or phone-based land lines; and
(g) allowing multiple carriers and multiple users to exchange information to engage in transaction processing.

7. The method of claim 6, further comprising:
(h) transmitting wireless information.

8. The method of claim 1, further comprising:
(f) managing the system data for a plurality of shipping service users.

9. The method of claim 8, further comprising:
(g) managing providers of other business services and resellers that are linked via the portal to carriers and shipping service users as well as authorized administrators.

10. The method of claim 8, further comprising:
(g) managing pricing and costing of shipping services provided by the carrier.

11. The method of claim 8, further comprising:
(g) managing revenue-shares and distribution of cost savings resulting.

12. The method of claim 8, further comprising:
(g) managing a communication flow to shipping service users and carriers.

13. A method of obtaining shipment delivery data including an electronic service and shipment monitoring system for tracking a shipment by a carrier on behalf of a shipping service user, the system being interconnected with the database of the shipping service user and the carrier using the electronic service, the method comprising:
(a) receiving at the shipment monitoring system, shipping information of the shipment by the carrier from the shipping service user;
(b) calculating expected delivery data for the shipment corresponding to the shipping information;
(c) receiving actual shipment delivery data from the carrier;
(d) determining in response to the expected data, and the actual data, if the shipment is out of compliance.

14. The method of claim 13, further comprising:
(e) compiling the expected and actual delivery data by relevant carrier;
(f) comparing carrier data; and
(g) calculating the efficient method based on expected and actual data.

15. The method of claim 13, further comprising determining if the shipment is eligible for a refund from the carrier, and making a refund request.

16. The method of claim 13, further comprising reporting the information via the electronic service.

17. The method of claim 15, further comprising tracking the refund requests.

18. The method of claim 17, further comprising sharing the refund between the shipping services user and a third party.

19. The method of claim 18, further comprising tracking and receiving the refund by the third party.

20. A method for identifying an entitlement to a refund for late delivery of a shipment, including a web-based service delivered by a portal and a transaction and refund processing system for tracking the movement of a shipment by a carrier on behalf of a shipping service user, the transaction and refund processing system being interconnected with a database of the shipping service user and the carrier using the internet, the method comprising:
(a) receiving at the transaction and refund processing system, shipping information of the shipment by the carrier from the shipping service user;
(b) calculating an expected delivery date and time for the shipment;
(c) receiving an actual shipment delivery information, including date and time, from the carrier; and
(d) determining a refund eligibility for a late delivery of the shipment.

21. A shipment monitoring system for identifying an entitlement to refund for late delivery of a shipment comprising:
(a) a database user supplied shipment information;
(b) software for calculating an expected delivery for the shipment;
(c) software configured to search the database of a carrier to determine an actual shipment delivery and compare the actual delivery to the expected delivery to determine if the actual delivery is within guarantees;
(d) computing software for computing an eligible refund amount for the shipment;
(e) processing software for processing a refund claim with the carrier to enable the shipping service user to receive credit and to ensure that the credit is received by the shipping service user; and
(f) reporting software for tracking and identifying out of compliance deliveries, eligible refunds and a status of the refunds and deliveries.

22. The shipment monitoring system of claim 21, further comprising including a portal for facilitating a web-based service.

23. The shipment monitoring system of claim 22, further comprising an internet connection with user information.

24. The shipment monitoring system of claim 23, further comprising an internet connection with a carrier data base monitoring system.

25. The shipment monitoring system of claim 22, further comprising an internet connection with an online business services portal of a reseller or other service provider for tracking and identification of late delivered shipments to enable refunds requests by the reseller.

26. The shipment monitoring system of claim 24, further comprising an electronic linking mechanism through a landline connected to one or more carrier databases and a shipping service user database such that the carrier database and shipping service user database share data.

27. The shipment monitoring system of claim 26, further comprising a wireless device for/connected to the shipping service database.

28. The shipment monitoring system of claim 27, further comprising software for administration of the portal by administering at least one of the following:
managing the carriers, shipping service users, schedules and priorities of those permitted to access and use the system;
managing providers of other business services and resellers that are linked via the portal to carriers and shipping service users as well as authorized administrators;
managing pricing and costing of services;
managing revenue-shares and distribution of cost savings; or
managing a flow of communication to shipping service users and carriers.

29. The shipment monitoring system of claim 27, further comprising refund tracking module.
